(19) United States
(12) Patent Application Publication
(10) Pub. No.: US 2025/0327905 A1
(43) Pub. Date: Oct. 23, 2025

(54) PULSED FIBER-LASER ARCHITECTURE

(71) Applicant: Raytheon Company, Tewksbury, MA (US)

(72) Inventor: Fabio Di Teodoro, Hacienda Heights, CA (US)

(21) Appl. No.: 18/640,793

(22) Filed: Apr. 19, 2024

(51) Int. Cl. G01S 7/484; H01S 3/067; H01S 3/094; H01S 3/10; H01S 3/16; H01S 3/30

(52) U.S. Cl. CPC G01S 7/484; H01S 3/06716; H01S 3/06729; H01S 3/094003; H01S 3/094042; H01S 3/10053; H01S 3/161; H01S 3/1616; H01S 3/302; H01S 2302/00; H01S 2303/00

(57) ABSTRACT

A power amplifier module (PAM) includes an input that receives a first beam at a signal wavelength (λₛ) from a seeder laser source (SLS) which includes previous stages of a multi-stage fiber-based optical amplifier chain. The PAM includes an optical pump laser (OPL) that generates an optical pump beam at a pump wavelength (λₚ). The PAM includes a fiber-optic output configured to fusion splice to a large-core rare-earth doped power amplifier fiber (PAF). The PAM includes a wavelength-division-multiplexer (WDM) configured to spectrally combine the first beam with the optical pump beam into a single combined beam that the WDM outputs into a core of the PAF via the fiber-optic output. The λₚ is an in-band wavelength at which the optical pump beam emitted by the OPL optically pumps the core such that the PAF, in response to receiving the combined beam, emits an output beam at wavelength>2 μm.

### TECHNICAL FIELD

This disclosure relates generally lasers. More specifically, this disclosure relates to a pulsed fiber-laser architecture at 2 μm wavelength.

### BACKGROUND

Light detection and ranging (LIDAR) and remote sensing transmitters that operate at approximately 2 micrometers (um or μm) wavelength offer some advantages including atmospheric transmission, detector technology, compatibility with optical materials, and covert operation. In this disclosure, the symbol ˜ denotes approximately, for example, ˜2 μm. Thulium (Tm) fiber lasers operating in this ˜2 μm wavelength range are becoming increasingly popular due to favorable size, weight, power consumption, ruggedness, and overall producibility. Currently, pulsed 2 μm fiber lasers fall short of requirements related to pulse energy and peak power due to limitations hampering the fabrication of large-core fibers.

### SUMMARY

This disclosure relates to a pulsed fiber-laser architecture at 2 μm wavelength.

In a first embodiment, an apparatus is a final-stage power amplifier module (PAM) for terminating a multi-stage fiber-based optical amplifier chain. The PAM includes a first input configured to receive a first beam at a signal wavelength (λₛ) from a seeder laser source (SLS) which includes previous stages of the chain. The PAM includes an optical pump laser (OPL) configured to generate an optical pump beam at a pump wavelength (λₚ). The PAM includes a fiber-optic output configured to fusion splice to a large-core rare-earth doped power amplifier fiber (PAF). The PAM includes a spectral combiner including a second input coupled to the OPL. The spectral combiner is configured to spectrally combine the first beam with the optical pump beam into a single combined beam that the spectral combiner outputs into a core of the PAF via the fiber-optic output. The pump wavelength (λₚ) is an in-band wavelength at which the optical pump beam emitted by the OPL optically pumps the core of the PAF such that the PAF, in response to receiving the combined beam, emits an output beam at an emission wavelength greater than 2 μm.

In a second embodiment, a system is a long-range light detection and ranging (LIDAR) transmitter. The LIDAR transmitter includes a seeder laser source (SLS) including previous stages of a multi-stage fiber-based optical amplifier chain configured to generate a first beam at a signal wavelength (λₛ). The LIDAR transmitter includes a large-core rare-earth doped power amplifier fiber (PAF). The LIDAR transmitter includes a final-stage power amplifier module (PAM) for terminating the chain. The PAM includes a first input configured to receive the first beam at the signal wavelength λₛ from the SLS. The PAM includes an optical pump laser (OPL) configured to generate an optical pump beam at a pump wavelength (λₚ). The PAM includes a fiber-optic output configured to fusion splice to the PAF. The PAM includes a wavelength-division-multiplexer (WDM) that includes a second input coupled to the OPL. The WDM is configured to spectrally combine the first beam with the optical pump beam into a single combined beam that the WDM outputs into the core of the PAF via the fiber-optic output. The pump wavelength λₚ is an in-band wavelength at which the optical pump beam emitted by the OPL optically pumps the core of the PAF such that the PAF, in response to receiving the combined beam, emits an output beam at an emission wavelength greater than 2 μm.

In a third embodiment, a method of operating a final-stage power amplifier module (PAM) of a multi-stage fiber-based optical amplifier chain. The method includes receiving a first beam at a signal wavelength (λₛ) from a seeder laser source (SLS) which includes previous stages of the chain. The method includes generating, at an optical pump laser (OPL), an optical pump beam at a pump wavelength (λₚ). The method includes spectrally combining, using a spectral combiner, the first beam with the optical pump beam into a single combined beam that outputs into a core of a large-core rare-earth doped power amplifier fiber (PAF) via an fiber-optic output. Within the method, the pump wavelength (λₚ) is an in-band wavelength at which the optical pump beam emitted by the OPL optically pumps the core of the PAF such that the PAF, in response to receiving the combined beam, emits an output beam at an emission wavelength greater than 2 μm.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1A illustrates a resonant energy transfer between adjacent ions of Tm-doped fibers undergoing an inter-ion cross-relaxation process;

FIG. 1B illustrates a graph of Tm-doped fiber absorption cross section versus wavelength;

FIG. 1C illustrates a detailed view of the Tm-doped fiber absorption cross section near a tandem-pumping wavelength interval, according to this disclosure;

FIG. 2A illustrates in-band absorption cross section of Ho ions versus wavelength, according to this disclosure;

FIG. 2B illustrates energy levels (⁵I₇ and ⁵I₈) for Ho ions for the operation of Ho-doped fiber laser source, according to this disclosure;

FIG. 3A illustrates a block diagram of architecture of a fiber laser transmitter designed for operation at wavelength greater than 2 μm, according to this disclosure;

FIGS. 3B and 3C illustrate examples of a cross-section of a fiber within the combiner of FIG. 3A, according to this disclosure;

FIG. 4 illustrates a graph of V number versus wavelength for fibers of different core diameters, according to this disclosure;

FIG. 5 illustrates a block diagram of architecture of Raman-shifted fiber laser transmitter, according to this disclosure;

FIG. 6 illustrates a graph of Raman fiber amplifier (RFA) wavelength versus power amplifier module (PAM) wavelength for various Raman fibers having different dopants, according to this disclosure;

FIG. 7 illustrates a schematic view of a coherently beam-combined fiber laser transmitter, according to this disclosure; and

FIG. 8 illustrates a beam overlapping device within the coherently beam-combined fiber laser transmitter of FIG. 7, according to this disclosure.

### DETAILED DESCRIPTION

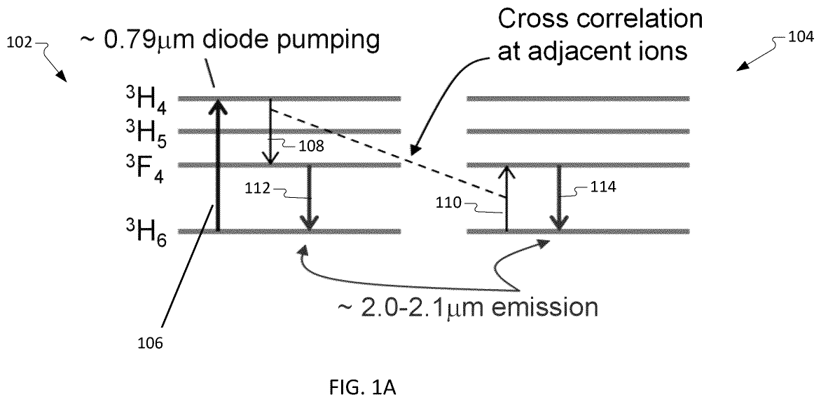

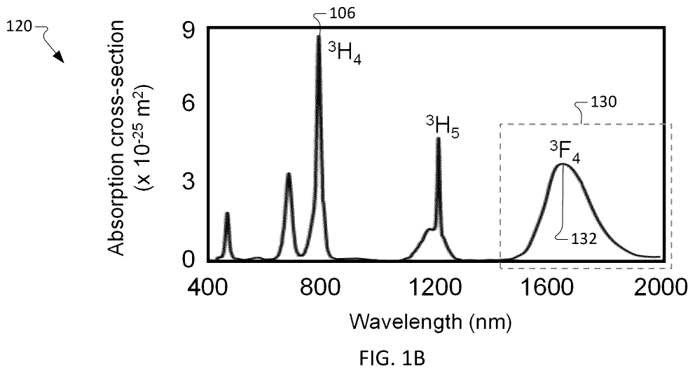

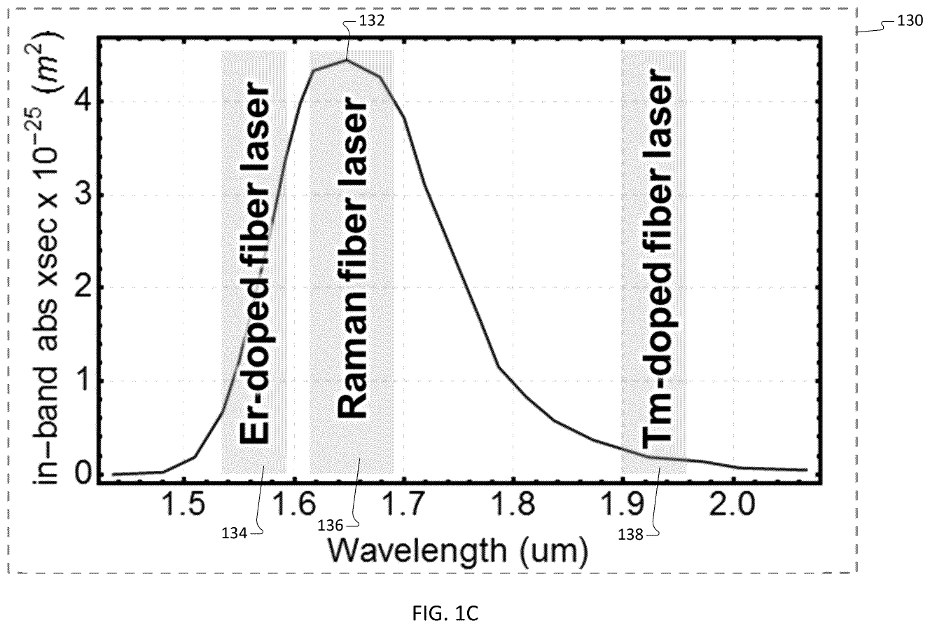

FIGS. 1 through 8, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

It may be advantageous to set forth definitions of certain words and phrases used throughout this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

FIGS. 1A-1C illustrate properties of Tm-doped fibers that are exploited in embodiment of this disclosure. FIG. 1A illustrates a resonant energy transfer between adjacent ions of Tm-doped fibers undergoing an inter-ion cross-relaxation process. That is, energy levels of Tm ions relevant to the operation of Tm-doped fiber laser source are shown in FIG. 1A. A first and second energy level schemes 102 and 104 correspond to adjacent ions, respectfully. A first energy change 106 corresponds to diode pumping at approximately 790 nanometers (nm), and is associated with an absorption cross-section peak at ³H₄. The first energy change 106 corresponds to a lasing level. An energy reduction 108 in the first energy level scheme 102 and an energy increase 110 in the second energy level scheme 104 demonstrate a cross correlation at adjacent ions. Emissions 112 and 114 at a wavelength of approximately 2.0 to 2.1 micrometers are associated with the adjacent ions.

FIG. 1B illustrates a graph 120 of Tm-doped fiber absorption cross section of holmium (Ho) ions versus wavelength. The greatest absorption cross-section peak at ³H₄ corresponds to the first energy change 106. A portion 130 of the graph 120, which includes a tandem-pumping wavelength interval (1900-1950 nm) with a peak 132 at ³F₄, is shown with greater detail in FIG. 1C.

FIG. 1C illustrates a detailed view of the Tm-doped fiber absorption cross section near a tandem-pumping wavelength interval, according to this disclosure. That is, the in-band absorption cross section of Tm ions provides possible spectral windows 132, 134, and 138 for optical pumping.

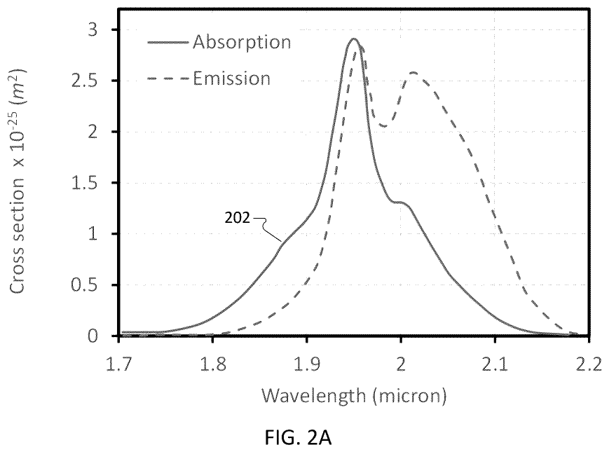

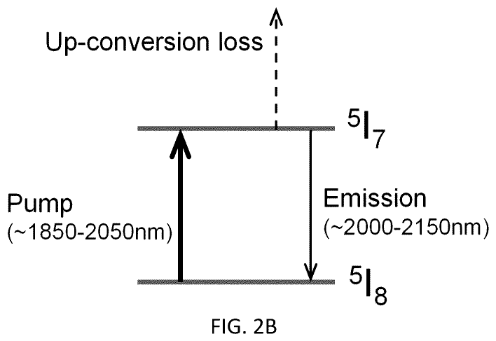

FIG. 2A illustrates in-band absorption cross section 202 of Ho ions versus wavelength, according to this disclosure. A calculated relative power (Pᵣₑₗ) in a tandem-pumped Tm-doped fiber amplifier built with a large-mode area (LMA) fiber overlapped relative to an attainable power in the same fiber if diode-pumped at approximately 790 nanometers (nm), plotted versus tandem-pumping wavelength.

FIG. 2B illustrates energy levels (⁵I₇ and ⁵I₈) for Ho ions for the operation of Ho-doped fiber laser source, according to this disclosure. A pump transition from ⁵I₈ to ⁵I₇ occurs within the wavelength range ˜1850-2050 nm. In reverse, an emission transition occurs within the wavelength range ˜2000-2150 nm.

The energy levels shown in FIG. 2B can be used to show a definition of calculated relative power of FIG. 2A. More particularly, a definition of relative power Pᵣₑₗ as the ratio between power attainable for diode-pumping at ˜790 nm (P₇₉₀) and power attainable in the case of tandem pumping (P_{TP}), which is in turn equal to the ratio between absorption cross section at tandem-pumping wavelength, α(λ_{TP}), and absorption cross section at ˜790 nm, α₇₉₀. The relationship expressing relative power Pᵣₑₗ is based on an assumption that the power attainable in the fiber amplifier is limited by the onset of nonlinear effects such as stimulated Brillouin scattering and on the fact that the threshold power for nonlinear effects is inversely proportional to the fiber length. In turn, the required fiber length for efficient operation of the fiber amplifier is inversely proportional to the fiber linear absorption coefficient.

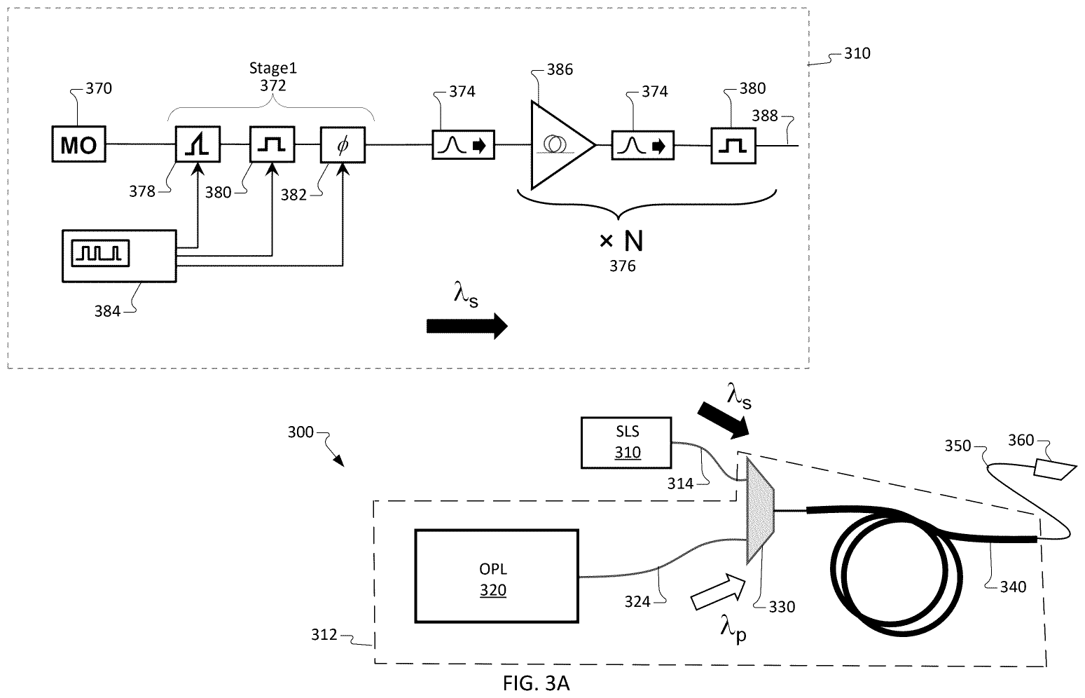

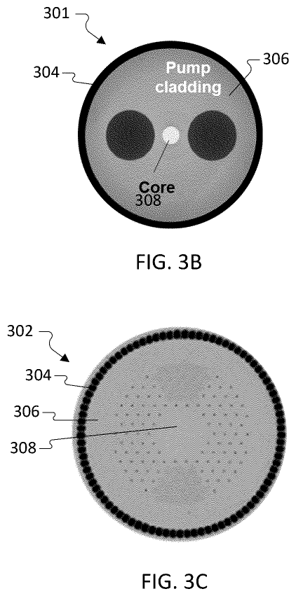

FIGS. 1A-2B can be used as a basis for comparison to explain the technical advantages provided by the transmitters of this disclosure shown FIGS. 3-8, as described further below. LiDAR and remote sensing transceivers operating at a longer than 2 μm (also referred to as super-2 μm) wavelength exhibit distinct benefits over traditional near-infrared (1-1.5 μm wavelength) devices, and some of these benefits include retina-safe (eye-safe) operation, lower scattering loss in propagation through the atmosphere, and higher number of photons emitted/received for given laser pulse energy. In addition to the emission wavelength (λₑ) being longer than 2 μm, laser transmitters suitable for these transceivers must typically satisfy a number of concurrent requirements, which include: high pulse energy and/or high average power for engaging targets at a long range (for example, a distance of tens of kilometers); narrow (e.g., <1 GHZ) or single-frequency spectral width; compatibility with the use of narrow-band spectral filters to discriminate return signals from ambient background and/or with coherent detection; excellent beam quality to maintain a small illumination cross section at range, thus maximizing return-signal strength and/or retaining ability to spatially resolve target features; compact form factor to facilitate deployment in flight platforms where space is at a premium; and rugged architecture to withstand harsh mechanical and thermal conditions.

In addressing these concurrent requirements, fiber lasers (FLs) offer unique advantages over more traditional solid-state laser technologies based on bulk crystal gain media. Benefits of FLs include an inherently rugged build consisting of discrete monolithic components fusion-spliced to each other without free-space optical paths subject to being misaligned by shock and vibration; reliance on mature optical materials developed through industrial processes; and flexibility in packaging. In particular, thulium (Tm) doped FLs (TDFLs) can conveniently operate within an atmospheric transmission window having a spectral range of 2039-2040 nm. Holmium (Ho) doped FLs (HDFLs) can operate at wavelength less than 2090 nm where the atmospheric transmission is even more favorable. The atmospheric transmission window avoids wavelengths subject to water absorption or beyond 2.1 μm.

Conventionally, diode lasers are viewed as generally desirable for optically pumping FLs by virtue of their low cost, reliability, high power, and high electric-to-optic efficiency. However, diode lasers fail to satisfy the concurrent requirements described herein, and therefore are not suitable to perform the functions performed by the transmitters of this disclosure. High-power diode lasers suitable for optical pumping of fiber laser sources exhibit relatively poor beam quality, and the output beam from theses high-power diode lasers cannot be optically coupled into single-transverse-mode fiber cores. Instead, the diode-laser-generated pump light is injected into a multimode waveguide surrounding the fiber core, which is referred to as “pump cladding.” A fiber that is optically pumped in this pump cladding manner is referred to as being “cladding pumped.”

In the case of TDFLs, the absorption spectrum of Tm-doped silica is such that ˜790 nm is the only wavelength at which one can find high-power diode lasers suitable for optical pumping. However, ˜790 nm wavelength is much shorter than the desired emission wavelength ˜2 μm, which means that using these diode lasers as optical pumps leads to a significant quantum defect (QD), which is related to the difference between optical-pump and emission wavelengths (λₚᵤₘₚ and λₗₐₛₑᵣ, respectively) and defined according to Equation 1.

$$QD = 1 - \frac{{λ}_{pump}}{{λ}_{laser}} \qquad ( 1 )$$

In diode-pumped TDFLs, the QD typically exceeds 60%. By comparison, Ytterbium(Yb)-doped FLs operating at ˜1 μm wavelength exhibit QD<10%. The high QD of diode-pumped TDFLs translates into a low optical efficiency (<40%) and substantial waste-heat deposition within the fiber during operation at high power. Increasing the Tm doping concentration in the core of TDFLs is a well-known approach to boosting the TDFL efficiency through a process of resonant inter-ion cross-relaxation, schematically illustrated in FIG. 1A, which can in principle double the quantum efficiency (2 photons emitted for each pump photon absorbed) and potentially lead to optical efficiency >70%. However, heavily doping the fiber core with Tm ions carries undesirable consequences. Particularly, to prevent the Tm ions from clustering within the core of the heavily doped fiber, which would severely reduce their energy storage capability, suitable co-dopant species must be added to the silica core composition as dilution agents.

The most effective dilution agent compatible with Tm ions is aluminum (Al), which is relatively easy to add to silica cores through standard chemical vapor deposition processes used in optical fiber fabrication. Unfortunately, both Tm and Al dopants contribute to a substantial refractive index increase in the core and consequently raise the core numerical aperture (NA), which is defined according to Equation 2, where n_{core} denotes the refractive index of the fiber core and n_{clad} denotes the refractive index of the fiber cladding. In turn, relatively high NA values preclude the possibility of designing fibers with both large core (desirable for high pulse peak power with minimal nonlinear effects) and good beam quality (desirable for long-range LiDAR) as the number of guided transverse modes for a given core diameter increases with the core NA.

$$NA = \sqrt{{n}_{core}^{2} - {n}_{clad}^{2}} \qquad ( 2 )$$

Conventionally, this high NA problem has been addressed primarily through fiber designs in which the value of n_{clad} is deliberately increased to keep the NA low even in the presence of a high n_{core} value. This remedy is implemented by co-doping with germanium (Ge) an annular region of the silica cladding around the core, referred to as the “pedestal.” While the pedestal fiber design has attained some success supporting good beam quality in heavily Tm-doped fiber of core diameter up to 20-25 μm, the pedestal acts as a multi-mode waveguide, which becomes more strongly coupled to the core as the core diameter increases and, correspondingly, the core NA is reduced. In larger-core fibers, more light leaks from the core into the pedestal and is guided and amplified therein, resulting in appreciable degradation of the output beam quality caused by the presence of significant optical power in high-order transverse modes. Transverse-mode competition influenced by varying thermo-mechanical conditions in and around the fiber leads to far-field beam pointing instability, which is especially detrimental for LiDAR and other types of remote sensing which need to maintain a tight illumination spot on target.

In the case of HDFLs, the absorption cross section of Ho ions does not exhibit features compatible with typical operation wavelengths of high-power diode lasers. Consequently, Ho-doped fibers are usually pumped by TDFLs operating in the ˜1900-2050 nm wavelength range, which corresponds to the in-band ⁵I₈→⁵I₇ pump transition shown in FIG. 2B. Conventionally, HDFLs are cladding pumped by one or more TDFLs, which makes it necessary to set the Ho-doping concentration in the fiber core to values of at least a few wt. % to ensure complete pump absorption along fibers of just few-meter length. However, neighboring excited-state Ho ions doped in silica-based fibers are known to interact in a pairwise fashion, resulting in an energy exchange which up-converts one ion to a higher non-lasing energy level, while transitioning the other to the ground energy level. This ion-pairing effect along with quenching of the Ho-ion excited-state lifetime caused by ion clustering, causes highly-doped HDFLs to be optically inefficient. In addition, as is the case for TDFLs, relatively high Ho doping concentrations raises the core refractive index n_{core}, which has been addressed by resorting to pedestal designs which hinder the fabrication of large-core fibers capable of predominantly fundamental-transverse-mode operation.

In this disclosure provides a power-scalable fiber-laser architecture for operation at a wavelength greater than >2 μm (as described further below with FIGS. 3A-8), which affords high pulse energy/peak-power suitable for long-range LiDAR/remote-sensing applications without incurring detriments related to beam quality degradation or to loss of spectral brightness caused by unwanted nonlinear optical effects.

FIG. 3A illustrates a block diagram of architecture of a fiber laser transmitter 300 designed for operation at wavelength greater than 2 μm, according to this disclosure. The transmitter 300 includes a seeder laser source (SLS) 310 and a power amplifier module (PAM) 312. The PAM 312 includes an optical pump laser (OPL) 320, a wavelength-division-multiplexer (WDM) 330, a power amplifier fiber (PAF) 340. The transmitter 300 additionally includes a delivery fiber 350, and a terminal beam-expanding endcap 360. The WDM 330 combines an SLS output 314 at signal wavelength λₛ with the OPL output 324 at pump wavelength λₚ. The WDM 330 is one example of a spectral combiner that the PAM 312 includes, but the spectral combiner of this disclosure is not limited to being a WDM. In some embodiments, the spectral combiner can be a fiber-coupled diffractive grating, or a fiber-coupled optical dichroic filter, or other device that combines signal and optical pump wavelengths within a same fiber.

As shown in the enlarged view, the SLS 310 includes a master oscillator (MO) 370, a first stage 372 of a multi-stage fiber amplifier chain, an inter-stage fiber-coupled optical filter 374 including an optical filters and fiber optic Faraday isolator, and N pre-amplifier chains 376 of the of a multi-stage fiber amplifier chain. The first stage 372 includes an intensity modulator 378, a time-gating intensity modulator 380, a phase modulator 382, and a pulse forming electronics 384. Each pre-amplifier chain 376 includes a fiber pre-amplifier 386, an optical filter 374, and a time-gating intensity modulator 380.

### Fiber-Based Seeder Laser Source (SLS)

The architecture for the all-fiber base laser transmitter 300 is designed for high power operation with high spectral and spatial beam quality.

The architecture starts with an all-fiber based seeder laser source (SLS) that generates a signal beam 314 of a desired signal wavelength λₛ. For example, the desired wavelength λₛ can be in the 2039-2040 nm spectral window. As another example, the desired wavelength λₛ can be or can be in a spectral range >2090 nm.

In the embodiment shown, the SLS 310 includes a pulsed seeder optical source followed by a fiber-based optical amplifier chain. In other embodiments in accordance with this disclosure, the pulsed seeder optical source is a discrete circuit or separate device that is coupled to the SLS 310, which includes the first stage 372 and the intermediate stages (e.g., N pre-amplifier chains 376) of the multi-stage fiber amplifier chain. The multi-stage fiber amplifier chain is terminated by the PAM 312, which is the final stage included in the chain.

The pulsed seeder optical source can be the single-frequency fiber-coupled master oscillator 370. The MO 370 can be a distributed-feedback or distributed-Bragg-reflector diode or fiber laser operating at the signal wavelength λₛ. The MO 370 outputs a seed, which is a laser signal that has desired characteristics except for its low power level, which can be in the range of milliwatts.

The multi-stage fiber amplifier chain includes two or more stages and inter-stage fiber-coupled optical filters and Faraday isolators 374. In some embodiments, all SLS components are fiber-coupled and fusion-spliced to each other to form the chain. In some embodiments, the fiber amplifiers in the chain include fused silica doped with rare-earth ions such as thulium (Tm) or holmium (Ho) or co-doped with both Tm and Ho ion species.

In some embodiments, the seed output from the MO 370 is amplitude-modulated by using the intensity modulator 378 and/or time-gating intensity modulator 380 to produce optical pulses. The intensity modulator 378, 380 can include a fiber-coupled electro-optic Mach-Zehnder modulator, an acousto-optic modulator, or semiconductor-optical amplifier in “switch” mode. In some embodiments, the MO 370 itself may be operated in pulsed mode, through gain-switching or Q-switching or mode-locking. Additional amplitude modulators can be added along the SLS 310 to increase the on/off pulse contrast.

In the SLS 310, the phase modulator 382 applies phase-modulation patterns onto the signal beam to broaden the spectrum to raise the threshold power for stimulated Brillouin scattering. In some embodiments, the broadened signal spectral linewidth may be >1 GHz. In some other embodiments, the signal spectral linewidth may instead be <1 GHz, that is as wide as just a few Hz to maximize the signal beam coherence length. In other embodiments, amplitude intensity modulators 378, 380 are omitted, and only the phase modulator 382 is included to enable the SLS 310 to operate in a frequency-modulated continuous-wave (FMCW) fashion. In some embodiments, the SLS 310 is entirely built with single-transverse-mode and polarization maintaining (PM) fibers connecting the SLS components. In some embodiments, the SLS average output power is in the 10-100 W range.

In some embodiments, the SLS 310 ends with a PM passive delivery fiber 388 of core diameter in the 10-20 μm range. The output end of the delivery fiber 388 is fusion-spliced to an input port of the PAM 312. In some embodiments, the SLS 310 can feature an additional fiber-coupled optical isolator and/or optical filter or other components that spectrally filter or optically isolate the SLS output 314, located between the final (i.e., N^{th}) SLS amplifier stage and SLS delivery fiber 388.

### Power Amplifier Module (PAM)

In a typical embodiment, the PAM comprises an optical pump laser (OPL), fiber-optic wavelength division multiplexer (WDM), and power amplifier fiber (PAF). The WDM features two input fiber-optic port and one output fiber-optic port, and its purpose is to spectrally combine two beams of different wavelengths (specifically, λₛ i.e., signal wavelength and λₚ i.e., pump wavelength), which are coupled into the input ports, into the core of a single fiber exiting the output port, with the two combined beams being the output from the SLS and OPL, respectively. The WDM output-port fiber is fusion-spliced to the PAF. That is, the PAM includes an output delivery optical fiber configured to fusion splice to the PAF.

In typical embodiments, the OPL output is delivered through a single-transverse-mode fiber, which is fusion-spliced to one fiber-optic port of the WDM as shown in FIG. 3.

In one embodiment of our invention, the wavelength of the OPL output, λₚ, lies within the in-band absorption feature of Tm-doped silica, which corresponds to energy transitions from the ground state to the ³F₄ excited state in Tm ions (see FIG. 1). In some embodiments, the OPL wavelength λₚ lies in the 1540-1600 nm range and, in this case, the OPL consists of an erbium(Er)-doped fiber laser source. In other embodiments, the OPL consists of a Raman-shifted Yb-doped fiber laser and λₚ then lies in the ˜1600-1700 nm range which corresponds to the peak in-band absorption for Tm ions. In other embodiments, which we may refer to as “tandem pumping”, the OPL comprises a Tm-doped fiber laser source and λₚ correspondingly lies in the ˜1900-1940 nm range.

The second fiber-optic port of the WDM component in the PAM is fusion-spliced to the output end of the SLS delivery fiber. In this disclosure, the OPL-emitted light as well as the SLS emitted light are coupled in and propagate through the core of the PAF. In the embodiments described above, the PAF core consists of silica-based material doped with Tm ions and λₛ falls in the ˜2039-2040 nm spectral window, which corresponds to a portion of Tm-doped fiber gain band that does not overlap with atmospheric water-absorption bands thereby resulting in good transmission through the atmosphere.

In typical embodiments, the concentration of Tm-ion doping in the PAF core is <1% in weight (<1% wt.), which is significantly lower than values of 4-5% wt. or higher, found in many fibers described in the prior art. This heavier doping is, in fact, required because in such fibers, the optical pump light is injected and propagates in the pump cladding, namely a multimode waveguide significantly larger than the core.

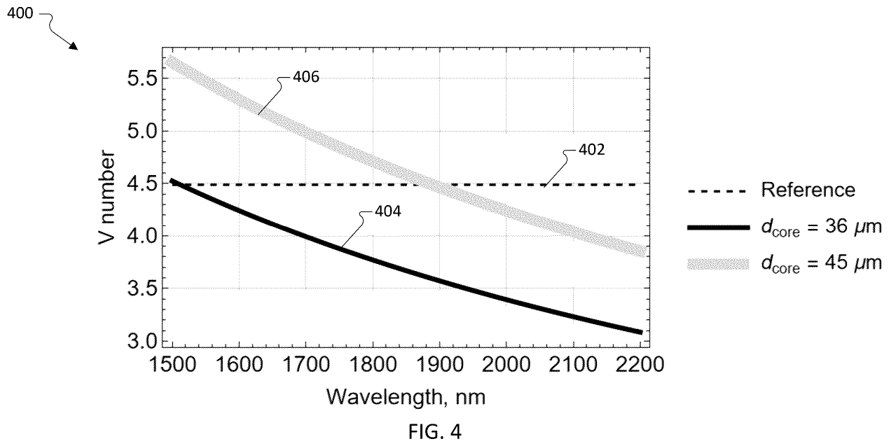

In other embodiments of the disclosed invention, the PAF may consist of a holmium (Ho)-doped silica-based fiber. The Ho-ion doping concentration can be 0.1% wt. or lower value consistent with sufficient dilution of Ho ions in the silica-based body of the fiber to prevent unwanted clustering of Ho ions (also known as ion pairing) and thus reduce optical loss compared to typical fibers mentioned in the prior art and improve the Ho-doped PAF optical efficiency. In these embodiments the OPLe-emitted light has a wavelength λₚ, which may fall in the ˜1900-2050 nm range with ˜1950 nm corresponding to the peak absorption in Ho ions, as shown in FIG. 4. In these embodiments, the SLS-generated light has wavelength λₛ which may be ˜2090 nm or longer and thus corresponds to a spectral region of good optical transmission through the atmosphere.

In yet another embodiment of the disclosed invention, the PAF may consist of a Tm/Ho co-doped silica-based fiber in which the Tm ions are optically pumped by the OPL emitting light in the ˜1540-1600, ˜1640-1690, or ˜1900-1940 nm range. The optically pumped Tm ions then transfer their excitation in a non-radiative fashion to Ho ions, which can emit at wavelength ˜2090 nm or longer. In this embodiment, the Tm/Ho doping concentration ratio is in the 10:1 to 20:1 range.

An important aspect is common to all such embodiments: the Tm and/or Ho dopant concentration in the PAF core is sufficiently low to maintain both the core refractive index and ensuing core NA at low values as well, which in turn reduces the number of guided transverse modes in the PAF core and promotes operation with good beam spatial quality even in relatively large cores of diameter of 40 μm or larger, as illustrated in FIG. 4.

At the same time, because the OPL-emitted pump light propagates in the core rather than in the cladding of the PAF, even such low dopant concentration can fully absorb the pump power along a relatively short fiber. In fact, the pump absorption per unit length, α_{clad-pump}, in cladding-pumped rare-earth-doped fibers can be written as

$${α}_{clad - pump} = \frac{{A}_{core}}{{A}_{clad}} {σ}_{abs} N . \qquad ( 3 )$$

Here, A_{core} and A_{clad} are the areas of the fiber core and pump cladding, respectively; σ_{abs} is the absorption cross section, which depends on which dopant is used and on the pump wavelength; and N is the absorbing dopant number density. In the case of core pumping, the corresponding pump absorption per unit length, α_{core-pump}, is instead given by:

$${α}_{core - pump} = {σ}_{abs} N . \qquad ( 4 )$$

Combining Equations (3) and (4) yields Equation (5):

$$\frac{{α}_{core - pump}}{{α}_{clad - pump}} = \frac{{A}_{clad}}{{A}_{core}} . \qquad ( 5 )$$

In Equation (5), for given dopant type, pump wavelength, and dopant number density, the pump absorption per unit length in the case of core pumping exceeds the corresponding value for cladding pumping by a factor given by the cladding/core area ratio. Equation (5) also implies that if we reduce by a factor of

$$\frac{{A}_{clad}}{{A}_{core}}$$

the number density of the dopant of the core-pumped fiber, the core-pumped and corresponding cladding-pumped fibers will exhibit the same pump absorption per unit length i.e., α_{core-pump}=α_{clad-pump}. In typical cladding-pumped rare-earth-doped fibers described in the art, the value of lies

$$\frac{{A}_{clad}}{{A}_{core}}$$

in the ˜20-400 range. A core-pumped fiber with dopant density reduced by this value still absorbs the same percentage of pump power in the same length of fiber compared to the more heavily doped, cladding-pumped fiber. Since the lightly doped core-pumped fiber absorbs the pump as effectively as the heavily doped cladding-pumped fiber having the same length, the former incurs no penalty in terms of optical efficiency or in suppressing nonlinear optical effects that cause unwanted degradation in spectral brightness. In fact, the threshold power for nonlinear effects is proportional to the core area and inversely proportional to the fiber length and is therefore higher in the core-pumped fiber which features larger core and same or shorter length compared to a cladding-pumped fiber.

In some embodiments, the transmitter 300 can include a tapered fiber-bundle combiner for use with all-fiber pumping and seeding of a tandem-pumped Tm-doped fiber amplifier, according to this disclosure. FIGS. 3B and 3C illustrate examples of a cross-section 301, 302 of a fiber within the combiner. The fiber cross-section 301, 302 includes an outer surface 304 of pump-carrying pigtail fiber, a cladding 306 of pump-carrying pigtail fiber, and a core 308 of pump-carrying pigtail fiber. In some embodiments, the fiber cross-section 301, 302 additionally includes: an outer surface of signal-carrying central fiber; a cladding of signal-carrying central fiber; and a core of signal-carrying central fiber. In some embodiments, the combiner includes a capillary tube that holds the combiner's fiber bundle, and a down-tapered portion of the combiner.

A fusion splice connects the combiner and the power amplifier Tm-doped fiber 340 of FIG. 3A, which can include the first fiber cross-section 301 of FIG. 3B or the second fiber cross-section 302 of FIG. 3C. The fiber 340 can be a Tm-doped fiber that includes an outer cladding, a pump cladding, and a core.

This disclosure provides multiple pumping options for in-band pumping. For example, a mode field diameter in a single-transverse-mode fiber is a function of core diameter, for different values of core numerical aperture (NA). The plot shows that for core diameters <10 μm, significant expansion of the mode field occurs well beyond the core boundaries.

FIG. 4 illustrates a graph 400 of V number versus wavelength for fibers of different core diameters (d_{core}), according to this disclosure. The core numerical aperture (NA) is assumed to be 0.06. The reference value 402 is the V number of a 25 mm-core-diameter fiber having NA=0.06 and operating at a 1050 nm wavelength. A core diameters of 36 micrometers and 45 micrometers correspond to the V number curves 404 and 406, respectively.

A graph can be shown of calculated unsaturated pump-power absorption versus fiber length, in the case of cladding pumping at an in-band wavelength and in the case of cladding pumping diode pumping, for various values of core/cladding diameter ratio, according to this disclosure.

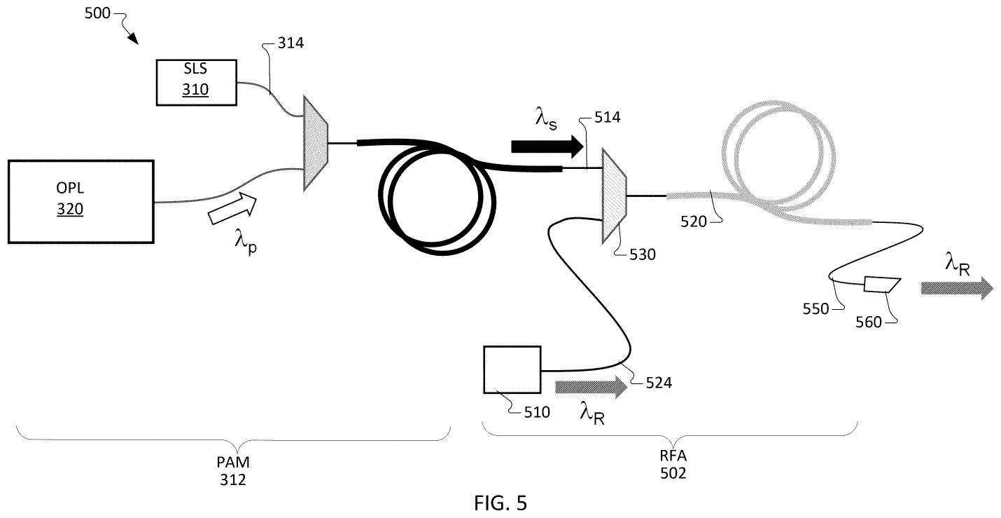

FIG. 5 illustrates a block diagram of architecture of Raman-shifted fiber laser transmitter 500, according to this disclosure. The transmitter 500 includes the fiber laser transmitter 300 of FIG. 3A, Raman seeder 510, and a second WDM 530 that combines the signal beam 312 (emitted by the SLS 310 and amplified in the PAM 312) having a wavelength μₛ with a Raman seeder beam 524 having a wavelength λ_{R}, which denotes the Raman-shifted value corresponding to λₛ. The transmitter 500 includes a Raman exit fiber 520. The transmitter 500 additionally includes a delivery fiber 550 and a terminal beam-expanding endcap 560, which can perform a similar function as corresponding components 350 and 360 of FIG. 3A.

The transmitter 500 includes a pipeline including the SLS 310 followed by the PAM 312 followed by a Raman fiber amplifier (RFA) module 502. The purpose of the RFA module 502 is to redshift the wavelength of the PAM output to obtain a new wavelength denoted as λ_{R} by executing the process of stimulated Raman scattering (SRS), in which input photons lose some of their energy into the excitation of molecular vibrations within the Raman fiber.

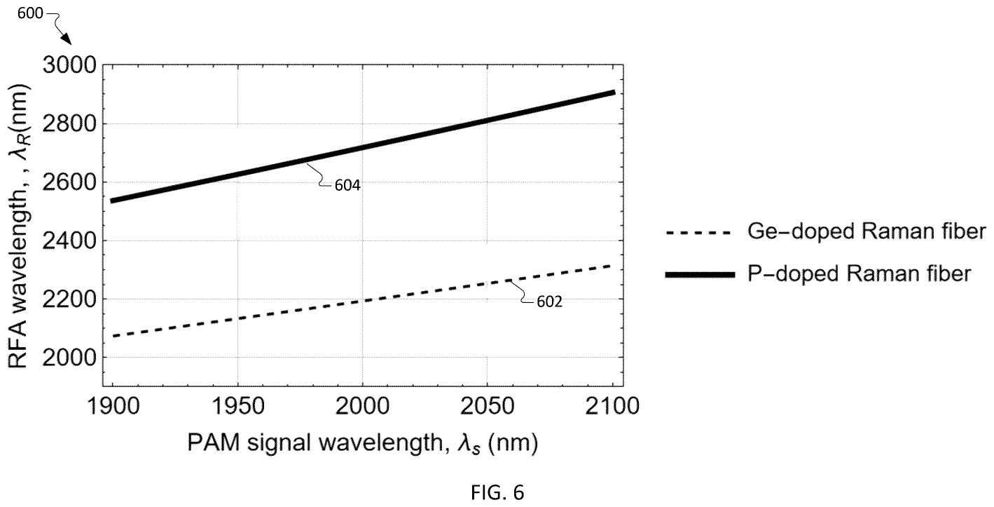

Refer temporarily to FIG. 6, which shows that the extent of the redshift depends on the specific material used in the RFA 502. In some embodiment, the RFA 502 includes a Raman fiber 520 with a germanium(Ge)-doped fused-silica core. The characteristic photon-energy loss caused by SRS in Ge-doped silica is ˜0.054 eV, which corresponds to an optical-frequency shift ˜13.2 THz or, equivalently, wavenumber shift ˜440 cm⁻¹. In another embodiment, the RFA 502 features a Raman fiber 520 with a phosphorous (P)-doped fused-silica core. In this P-doped fiber, the characteristic SRS-driven photon-energy loss is ˜0.164 eV, which corresponds to an optical-frequency shift ˜40 THz or, equivalently, wavenumber shift ˜1320 cm⁻¹.

Referring back to FIG. 5, the RFA 502 includes a fiber-optic WDM 530 (referred to as second WDM 530 to distinguish from the first WDM 330 within the PAM 312) which includes an output port fusion-spliced to the input end of the Raman fiber 520. This second WDM 530 is similar to the first WDM 330 used in the PAM 312, but designed to combine, into the core of exit fiber 520, the PAM output-beam 514 at wavelength λₛ with the corresponding Raman seeder beam 524 at the Raman-shifted wavelength λ_{R}.

The second input port of the second WDM 530 is fusion-spliced to the delivery fiber of Raman seeder 510. The Raman seeder 510 which can be a low-power laser source operating at the Raman-shifted wavelength λ_{R} and used as a seeder for the RFA module 502. The Raman seeder 510 can be a fiber-coupled single-mode diode laser that operates in a pulsed mode time-synchronized with the laser pulses emitted by the PAM 312. In some embodiments, the pulsed operation of the Raman seeder 510 source is obtained by directly modulating the drive current of the diode laser. In other embodiments, the Raman seeder 510 performs the pulsed operation by using an external electro-optic, acousto-optic, or semiconductor-based intensity modulator. In some embodiments, the temporal shapes of the PAM and RFA seeder emitted pulses 314 and 524, which are 1 ns long or longer, is such that the leading and trailing edge of the pulses 314 and 524 are as short as possible and no longer than just a few tens of picoseconds in duration, which results in significant mitigation of nonlinear self-phase modulation and ensuring modulation instability, while not impairing the efficiency of the SRS process. In this way, SRS can be the dominant nonlinear effect.

FIG. 6 illustrates a graph 600 of Raman fiber amplifier (RFA) wavelength versus power amplified module (PAM) wavelength for various Raman fibers having different dopants, according to this disclosure. More particularly, in the graph 600, Raman-shifted wavelength λ_{R} 602 and 604 is plotted versus the corresponding signal wavelength λₛ for a Ge-doped Raman fiber and P-doped Raman fiber, respectively.

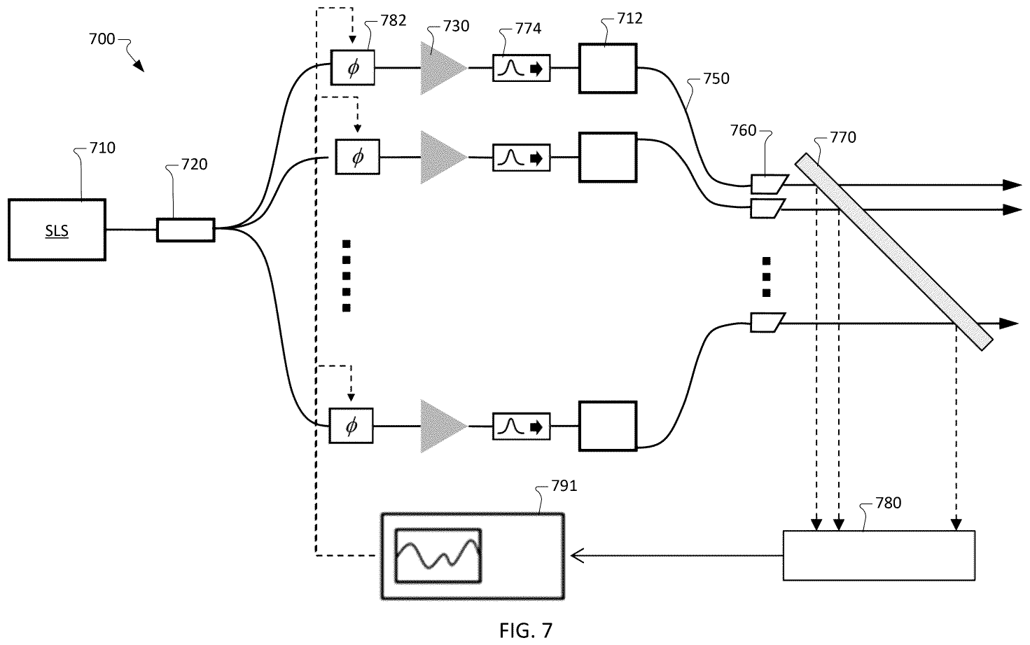

FIG. 7 illustrates a schematic view of a coherently beam-combined fiber laser transmitter 700, according to this disclosure. The transmitter 700 operates at a wavelength that is less than 2 μm.

The transmitter 700 includes an SLS 710, which can be the same as or similar to the SLS 310 of FIG. 3A. The transmitter 700 includes a fiber-optic splitter 720 that distributes the SLS output power equally across N all-fiber-based channels. Among the N all-fiber-based channels, each channel includes a phase modulator 782, a repeater fiber amplifier 730, an inter-stage fiber-coupled optical filter 774 including an optical filters and fiber optic Faraday isolator, a power amplifier module (PAM) 712, a delivery fiber 750, and a terminal beam-expanding endcap 760. The phase modulator 782, an inter-stage fiber-coupled optical filter 774, PAM 712, delivery fiber 750, and terminal beam-expanding endcap 760 can be the same as or similar to corresponding components 382, 374, 312, 350, and 360 in FIG. 3A. The transmitter 700 includes a beam sampler 770, a photodetector 780, and phase-correcting electronics 791.

Within the transmitter 700, the SLS 710 is coupled to (e.g., followed by) a fiber-optic splitter which distributes the SLS output power equally across N all-fiber-based channels. Each channel comprises an electro-optic phase modulator, a fiber amplifier used as a repeater to compensate for the optical loss caused by the splitting and thus supplying net optical gain exceeding N, and a PAM 312 configured according to any one of the embodiments described herein. The output beams exiting the N PAMs are coherently combined to form a single combined beam carrying to the cumulative power of all PAMs added together but exhibiting the same spatial beam quality as any one of them. To coherently combine the PAM output beams, in this embodiment, the transmitter 700 performs two functions: phase locking and beam spatial overlap.

To accomplish phase locking, the optical phase shifts caused by propagation of light in each of the N channels are equalized through an active opto-electronic feedback loop. Various suitable phase-locking loops can be implemented here, including the locking of coherence by single-detector electronic-frequency tagging (LOCSET) technique, stochastic parallel gradient descent (SPGD) technique, or other optical phase-locking techniques.

The spatial overlap of the beams in the far field can be obtained via tiling the PAM delivery fiber exit apertures, for example in a close-packed hexagonal arrangement. Spatial beam overlap can also be obtained in both near and far field using cascading of beam splitters and diffractive optical elements, or using other beam-overlap techniques.

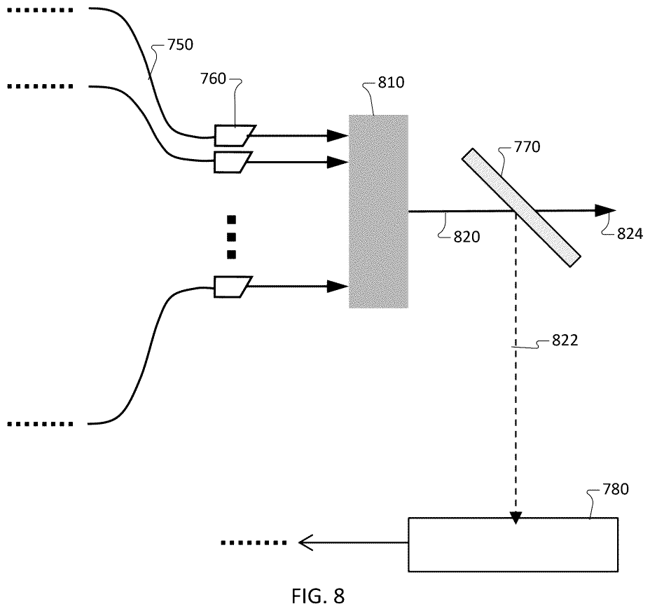

FIG. 8 illustrates a beam overlapping device 810 within the coherently beam-combined fiber laser transmitter 700 of FIG. 7, according to this disclosure. Within the coherently beam-combined fiber laser transmitter 800 of FIG. 8, the beam overlapping device 810 combines the N beams received from the N terminal beam-expanding endcaps 760 of each channel, and outputs a single combined signal 820 to the beam sampler 770.

The beam sampler reflects a portion 822 of the single combined signal 820 received, and transmits a remaining portion 824. The photodetector 780 receives the reflected portion 822 of the single combined signal 820.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A final-stage power amplifier module (PAM) for terminating a multi-stage fiber-based optical amplifier chain, the PAM comprising:
a first input configured to receive a first beam at a signal wavelength (λₛ) from a seeder laser source (SLS) which includes previous stages of the chain;
an optical pump laser (OPL) configured to generate an optical pump beam at a pump wavelength (λₚ);
a fiber-optic output configured to fusion splice to a large-core rare-earth doped power amplifier fiber (PAF); and
a spectral combiner including a second input coupled to the OPL, the spectral combiner configured to spectrally combine the first beam with the optical pump beam into a single combined beam that outputs into a core of the PAF via the fiber-optic output,
wherein the pump wavelength (λₚ) is an in-band wavelength at which the optical pump beam emitted by the OPL optically pumps the core of the PAF such that the PAF, in response to receiving the combined beam, emits an output beam at an emission wavelength greater than 2 μm.

2. The PAM of claim 1, wherein:
the core of the PAF is doped with thulium (Tm-doped) or co-doped with holmium (Ho) and thulium (Tm);
the fiber-optic output is configured to emit, into the core of the PAF, the combined beam of light at the emission wavelength that is within a spectral range from 2039 nanometers (nm) to 2040 nm; and
the core is optically core-pumped by the optical pump beam emitted by the OPL that comprises at least one of:
an erbium (Er) doped fiber laser source configured to emit light at the pump wavelength within a spectral range from 1540 nm to 1600 nm;
a Raman fiber laser source configured to emit light at the pump wavelength within a spectral range from 1600 nm to 1700 nm; or
a Tm-doped fiber laser source configured to emit light at the pump wavelength within a spectral range from 1900 nm to 1940 nm.

3. The PAM of claim 1, wherein:
the core of the PAF is purely doped with holmium (Ho-doped);
the fiber-optic output is configured to emit, into the Ho-doped core of the PAF, the combined beam of light at the emission wavelength that is approximately 2090 nanometers (nm) or greater; and
the core is optically core-pumped by the optical pump beam emitted by the OPL at the pump wavelength within a spectral range from 1900 nm to 2050 nm.

4. The PAM of claim 3, wherein the signal wavelength (λₛ) is approximately 2090 nanometers or greater.

5. The PAM of claim 1, wherein the core of the PAF is characterized by:
a large diameter greater than or equal to 30 millimeters (mm);
a doping-ion concentration less than or equal to 1%;
a low core numerical aperture less than or equal to 0.06; and
capable of operation by emitting the output beam exhibiting predominantly single-transverse-mode characteristics and beam-quality factor (M²) less than or equal to 1.5.

6. The PAM of claim 1, wherein:
the SLS operates in a frequency-modulated continuous-wave (FMCW) mode; and
the spectral combiner comprises a wavelength division multiplexer, fiber-coupled diffractive grating, or a fiber-coupled optical dichroic filter.

7. The PAM of claim 1, wherein the SLS operates in a pulsed mode such that the first beam includes amplitude-modulated optical pulses.

8. A long-range light detection and ranging (LIDAR) transmitter comprising:
a seeder laser source (SLS) including previous stages of a multi-stage fiber-based optical amplifier chain configured to generate a first beam at a signal wavelength (λₛ); and
a large-core rare-earth doped power amplifier fiber (PAF); and
a final-stage power amplifier module (PAM) for terminating the chain, the PAM comprising:
a first input configured to receive the first beam at the signal wavelength λₛ from the SLS;
an optical pump laser (OPL) configured to generate an optical pump beam at a pump wavelength (λₚ);
a fiber-optic output configured to fusion splice to the PAF; and
a wavelength-division-multiplexer (WDM) that includes a second input coupled to the OPL, the WDM configured to spectrally combine the first beam with the optical pump beam into a single combined beam that the WDM outputs into the core of the PAF via the fiber-optic output,
wherein the pump wavelength λₚ is an in-band wavelength at which the optical pump beam emitted by the OPL optically pumps the core of the PAF such that the PAF, in response to receiving the combined beam, emits an output beam at an emission wavelength greater than 2 μm.

9. The LIDAR transmitter of claim 8, further comprising:
a Raman fiber amplifier (RFA) configured to apply a process of stimulated Raman scattering (SRS) to the output beam emitted from the PAF of the PAM to reshift the emission wavelength to a Raman-shifted wavelength λ_{R}.

10. The LIDAR transmitter of claim 9, wherein the RFA comprises:
a third input configured to receive the output beam emitted from the PAF of the PAM;
a fourth input configured to receive a Raman seeder beam at the Raman-shifted wavelength λ_{R}; and
a second WDM configured to combine, into a core of a Raman exit fiber, the beams received via the third input and the fourth input.

11. The LIDAR transmitter of claim 10, wherein the core of the Raman exit fiber is at least one of:
a germanium(Ge)-doped fused-silica core, or
phosphorous(P)-doped fused-silica core.

12. The LIDAR transmitter of claim 8, wherein:
the core of the PAF is doped with thulium (Tm-doped) or co-doped with holmium (Ho) and thulium (Tm);
the fiber-optic output is configured to emit, into the core of the PAF, the combined beam of light at the emission wavelength that is within a spectral range from 2039 nanometers (nm) to 2040 nm; and
the core is optically core-pumped by the optical pump beam emitted by the OPL that comprises at least one of:
an erbium (Er) doped fiber laser source configured to emit light at the pump wavelength within a spectral range from 1540 nm to 1600 nm;
a Raman fiber laser source configured to emit light at the pump wavelength within a spectral range from 1600 nm to 1700 nm; or
a Tm-doped fiber laser source configured to emit light at the pump wavelength within a spectral range from 1900 nm to 1940 nm.

13. The LIDAR transmitter of claim 8, wherein:
the core of the PAF is purely doped with holmium (Ho-doped);
the fiber-optic output is configured to emit, into the Ho-doped core of the PAF, the combined beam of light at the emission wavelength that is approximately 2090 nanometers (nm) or greater; and
the core is optically core-pumped by the optical pump beam emitted by the OPL at the pump wavelength within a spectral range from 1900 nm to 2050 nm.

14. The LIDAR transmitter of claim 8, wherein the core of the PAF is characterized by:
a large diameter greater than or equal to 30 millimeters (mm);
a doping-ion concentration less than or equal to 1%;
a low core numerical aperture less than or equal to 0.06; and
capable of operation by emitting the output beam exhibiting predominantly single-transverse-mode characteristics and beam-quality factor (M²) less than or equal to 1.5.

15. The LIDAR transmitter of claim 8, wherein the SLS operates in a frequency-modulated continuous-wave (FMCW) mode.

16. The LIDAR transmitter of claim 8, wherein the SLS operates in a pulsed mode such that the first beam includes amplitude-modulated optical pulses.

17. The LIDAR transmitter of claim 8, further comprising:
a fiber-optic splitter configured to receive the first beam at a signal wavelength (λₛ) from the SLS, and to split the first beam into N fiber-based channels that include N PAMs, respectively,
wherein the SLS includes a common fiber-based seeder laser source composed from an array of laser sources, the SLS configured to generate the first beam at a signal wavelength (λₛ) as a coherent continuous-wave or pulsed wave that the splitter receives; and
a phase-locking loop that includes a beam sampler, photodetector, phase-correcting electronics, the phase-locking loop configured to receive and coherently combine N output beams respectively emitted from the N PAMs to generate a single beam having a cumulative optical power emitted by the N PAMs.

18. The LIDAR transmitter of claim 17, further comprising:
beam overlapping device configured to combine the N output beams received from the N fiber-based channels into a second single combined signal that the beam overlapping device outputs to beam sampler.

19. The LIDAR transmitter of claim 17, wherein the core of the PAF is doped with thulium (Tm-doped) or co-doped with holmium (Ho) and thulium (Tm).

20. A method of operating a final-stage power amplifier module (PAM) of a multi-stage fiber-based optical amplifier chain, comprising:
receiving a first beam at a signal wavelength (λₛ) from a seeder laser source (SLS) which includes previous stages of the chain;
generating, at an optical pump laser (OPL), an optical pump beam at a pump wavelength (λₚ); and
spectrally combining, using a spectral combiner, the first beam with the optical pump beam into a single combined beam that outputs into a core of a large-core rare-earth doped power amplifier fiber (PAF) via an fiber-optic output, and
wherein the pump wavelength (λₚ) is an in-band wavelength at which the optical pump beam emitted by the OPL optically pumps the core of the PAF such that the PAP, in response to receiving the combined beam, emits an output beam at an emission wavelength greater than 2 μm.
